(19) United States
(12) Patent Application Publication
(10) Pub. No.: US 2024/0358574 A1
(43) Pub. Date: Oct. 31, 2024

(54) PEG SUPPORT MEMBER

(71) Applicant: INNOVATIVE MEDICAL PRODUCTS, INC., Plainville, CT (US)

(72) Inventor: Jeffrey D. GORDON, Gainesville, GA (US)

(73) Assignee: INNOVATIVE MEDICAL PRODUCTS, INC., Plainville, CT (US)

(21) Appl. No.: 18/307,606

(22) Filed: Apr. 26, 2023

(51) Int. Cl. A61G 13/12

(52) U.S. Cl. CPC A61G 13/1285

(57) ABSTRACT

A peg support member, system and method of assembly includes one or more posts adapted to couple to an adjacent peg board opening, to provide improved holding of a peg. A method of cinching is also provided, wherein the peg support member can be rotated to advance the peg into a more centrally-located peg board opening, on account of the lever created thereby and the tapered profile of the peg support member body. Once in place, the peg support member body increases the holding area about the end of the peg, i.e., the vertical surface area, to limit bending or torsion of the peg, thereby improve holding characteristics and positioning of the patient.

### TECHNICAL FIELD

The present invention relates generally to a peg support member for positioning of a patient, and in particular for use with one or more pegs disposed in a peg board to support a patient during a surgical procedure or physical therapy procedure.

### BACKGROUND

During surgical procedures, surgeons desire to maintain a particular position of a patient on the operating room table. For example, the patient has a tendency to move as a result of forces applied by the surgeon, or by a robotic device, or other forces. For a variety of surgical procedures, peg boards may be used that are operably coupled to the OR table; peg boards offer customizable positioning via an array of peg board openings that received appropriately-sized pegs. By locating the patient on a peg board and inserting multiple pegs around the perimeter of the patient, the surgeon can fix the patient into a desired position for a variety of surgical procedures. For example, pegs may be located near the pubis synthesis, near the small of the back, near the should blades, and/or near the sternum, among other positions, to hold a patient. These pegs may also have a padded material to spread the load exerted on the patient by the peg to prevent damage of soft tissue, etc.

However, conventional arrangements of this sort have disadvantages of unwanted displacements of the peg from the peg board. The vertical thickness of the peg board, for example, is limited by the weight of the board itself. Some standards require a limit of 25 pounds (lbs.)/11.33 kilograms (kg.) for nurses handling the surgical equipment, for example. This limitation of the vertical thickness means that the surface area is also limited about the peg-peg board interface. Once in place and under load, the force acting on the peg by the patient generates a moment arm about that peg-peg board interface and deflection of the peg typically occurs due to the limited surface area interface, such as bending in the direction of angle α, as shown representatively in FIG. 7E. These disadvantages are particularly applicable for positioning the patient in the lateral decubitus position.

Accordingly, what is needed is peg support member for positioning of a patient that overcomes these disadvantages of the conventional approaches while improving the stability and positioning of the patient.

### SUMMARY

It is an object of the present invention to provide a peg support member for use with one or more pegs disposed in a peg board to support a patient during a surgical procedure that increases the effective surface area interface between the peg and the peg board.

It is another object of the present invention to provide a peg support member including one or more posts that are adapted to be disposed in adjacent peg board openings as that of the peg, for increasing the number of anchor points for the peg, thereby increasing stability and decreasing angular deflection of the peg.

It is another object of the present invention to provide a peg support member including a plurality of peg openings, each peg opening being adapted to receive a peg therein, the peg support member further including one or more posts that are each adapted to be disposed in an adjacent peg board opening.

It is another object of the present invention to provide a peg support member that can be rotated to advance the peg into a more centrally-located peg board opening, on account of the lever created thereby and the tapered profile of the peg support member body.

Other desirable features and characteristics will become apparent from the subsequent detailed description, the drawings, and the appended claims, when considered in view of this summary.

### DESCRIPTION OF THE DRAWINGS

Non-limiting and non-exhaustive embodiments of the present disclosure are described with reference to the following drawings. In the drawings, like numerals describe like components throughout the several views.

For a better understanding of the present disclosure, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 illustrates a front, top, right-side perspective view of a peg support member for positioning of a patient, according to an embodiment of the present invention;

FIG. 2 illustrates a front view of a peg support member for positioning of a patient thereof;

FIG. 3 illustrates a rear, bottom, left-side perspective view of a peg support member for positioning of a patient thereof;

FIG. 4 illustrates a top view of a peg support member for positioning of a patient thereof;

FIG. 5 illustrates a bottom view of a peg support member for positioning of a patient thereof;

FIG. 6 illustrates a right-side view of a peg support member for positioning of a patient thereof;

FIG. 7A illustrates an exemplary peg support member for positioning of a patient, the peg support member configured in a decoupled state prior to use, according to an embodiment of the present invention;

FIG. 7B illustrates a step in the set-up of an exemplary peg support member for positioning of a patient, the peg support member configured in a coupled state prior to inserting a peg therein, according to an embodiment of the present invention;

FIG. 7C illustrates another step in the set-up of an exemplary peg support member for positioning of a patient, the peg support member configured with a peg at least partially disposed in the peg support member where the peg support member is rotatably coupled to the peg board, according to an embodiment of the present invention;

FIG. 7D illustrates a further step in the set-up of an exemplary peg support member for positioning of a patient, the peg support member configured in a partially-loaded state where the peg support member is still rotatably coupled to the peg board, according to an embodiment of the present invention; and

FIG. 7E illustrates an exemplary peg support member for positioning of a patient, the peg support member configured in a rotatably-locked position wherein the peg exhibits increased support, according to an embodiment of the present invention.

### DETAILED DESCRIPTION

Non-limiting embodiments of the invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention. The drawings featured in the figures are provided for the purpose of illustrating some embodiments of the invention and are not to be considered as a limitation thereto.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive. Also, the term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

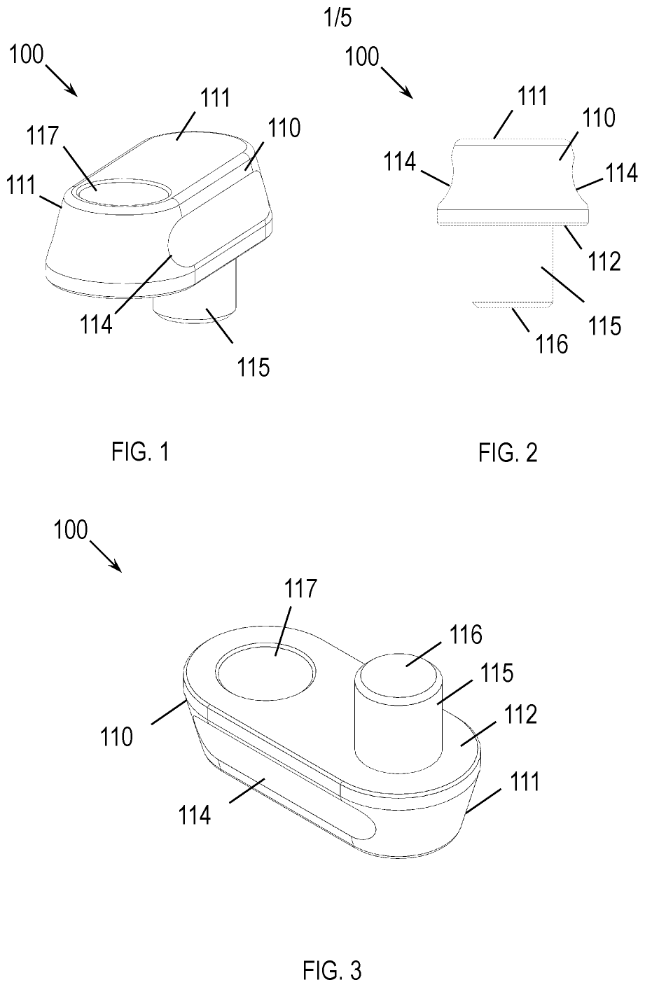

Referring to FIGS. 1-6, and. 7A-7E, a peg support member 100 and method of assembly for positioning of a patient is generally designated as element 100. Referring to FIGS. 1-6, a peg support member 100 may comprise a body 110 characterized by a generally tapered profile 113 extending between a top 111 and a bottom 112. One or more posts 115 may protrude outwardly from the body 110, extending a length, for example, from the bottom 112 to a post end 116. The length of the one or more posts 115 may be substantially the same as the depth of the corresponding peg board 103 for which the peg support member 100 is configured; similarly, the diameter of the one or more posts 115 may be appropriately sized to operably couple to the peg board opening 104. The peg support member 100 may further comprise one or more openings 117, each adapted to receive one or more pegs 105 in a through-hole configuration, so that the peg 105 may pass through said body 110 and be received by the desired peg board opening 104 when peg support member 100 is in an assembled configuration. One or more openings 117 may therefore be appropriately sized to operably couple to the peg 105.

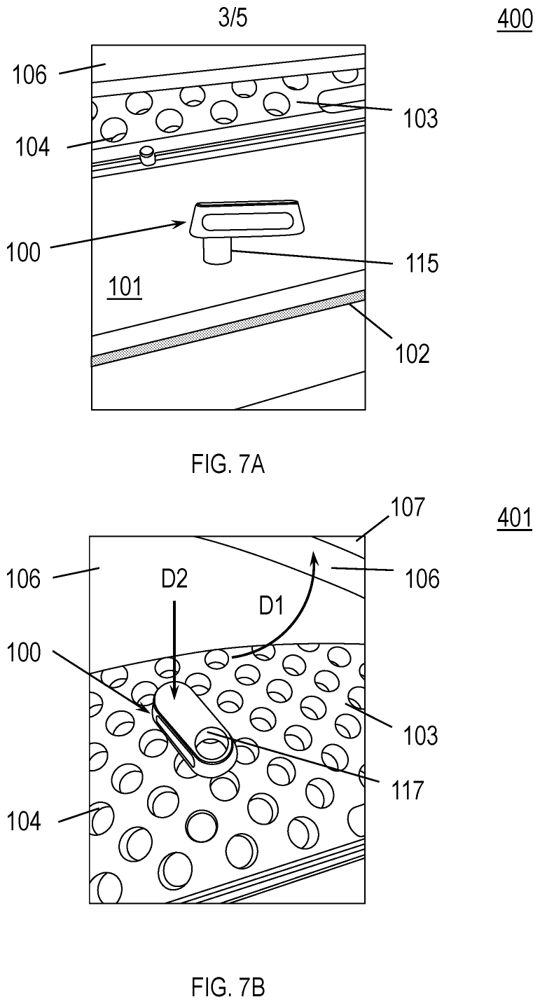

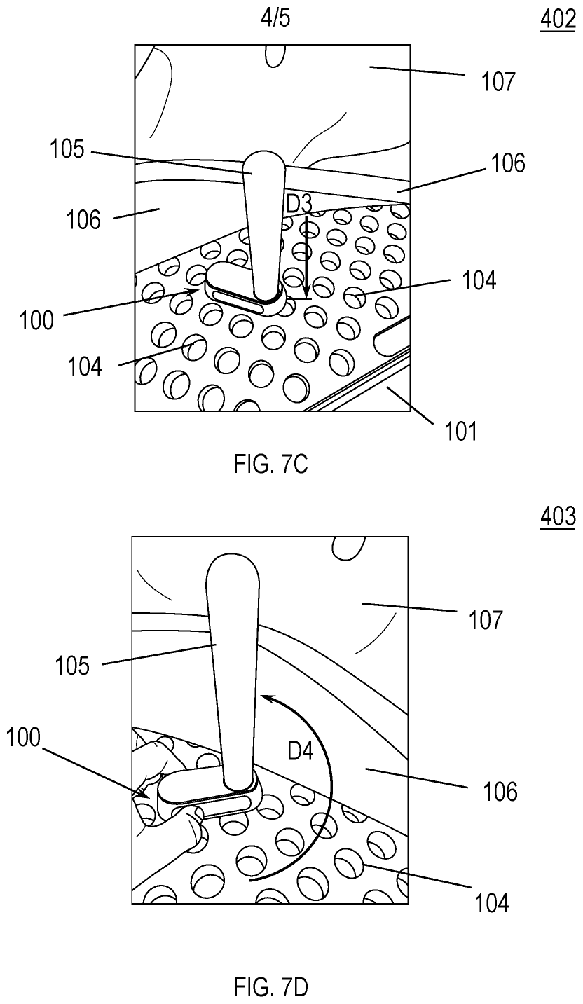

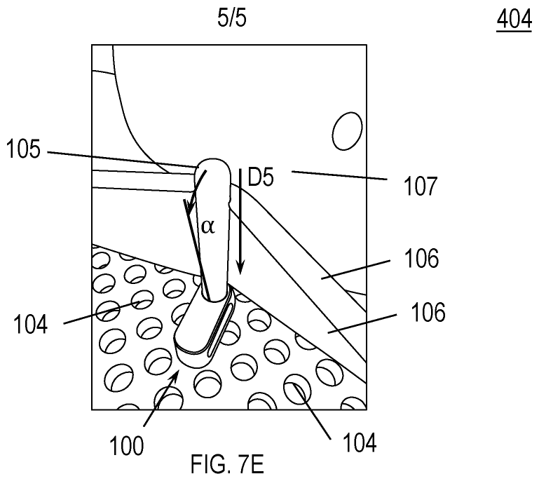

The peg support member 100 is adapted to couple, secure, and/or otherwise hold one or more pegs 105 to a peg board 103, such as shown in FIG. 7E. Among other advantageous aspects, the peg support 100 increases the surface area interface coupled to the peg 105 to increase the coupling characteristics of the peg 105 to the peg board 103, such as to reduce or substantially eliminate the deflection or bending of the peg 105 about angle a, as shown in FIG. 7E. Referring generally to FIGS. 7A-7E, the peg board 103 may be operably coupled to an operating table 101 via a side rail 102, or by any other method known in the art. Furthermore, the peg board 103 may be any suitable peg board for surgical applications, such as a peg board product manufactured and offered for sale by In Innovative Medical Products, Inc. as the MorphBoard® surgical peg board patient positioning system. Furthermore, any peg 105 known in the art may be used. Typically peg 105 materials may include aluminum, and typical peg board 103 materials may include high density polyethene (HDPE). The peg may include a pad (not shown) such as a peg foam pad for disposing on the peg, thereby surrounding the peg to dissipate the force generated by the peg on an area of the patient. Similarly, between the patient 107 and the peg board 103 and/or the peg 105, a sutable pad 106 may be disposed, to dissipate forces exerted on the patient, and to otherwise protect soft tissues of patient 107 such as a flat foam peg board pad.

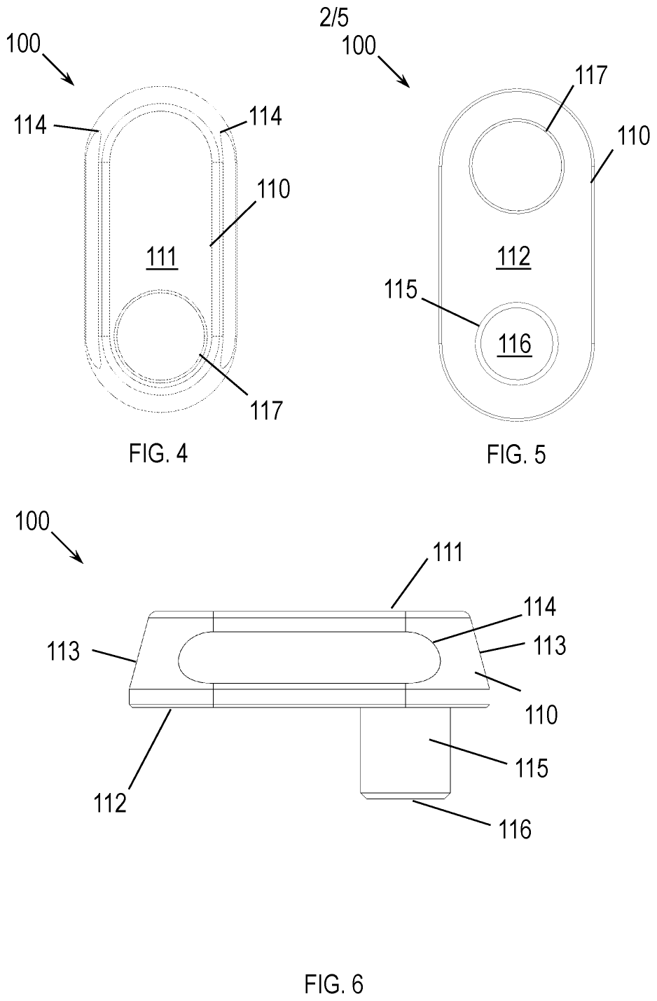

In a preferred embodiment of the present invention, the peg support member 100 may be characterized as having a height, i.e., the linear vertical distance between the top 111 and bottom 112 that is about the same length as the length of the post 115, i.e., linear vertical distance between the bottom 112 and the post end 116. However, the height of the body 110 may be more, such as two or three times the post 115 length, or less, such as one half or one quarter the post 115 length. The combination of the post 115 and the surface area interface of the opening 117 about the peg 105 generally provide improved holding or coupling characteristics of the peg 105 to the peg board 103. The height of the body 110 may also be non-uniform, such as a tapered or any other profile. The sides 113 of the body 110 may generally be characterized as having a tapered profile, so that the bottom 112 is larger than the top 111, in the dimensions shown in-plane of the view of FIG. 4. This tapered profile of the sides 113 and/or top 111 facilitates rotating the peg support member 100 under a pad 106, when the surgeon is positioning the peg 105, as will be further described. The sides 113 and/or top 111 may have one or more ergonomic grips 114 disposed therealong, the grips configured to provide the surgeon with better holding characteristics of the member 100. The peg support member 100 may be made of HDPE or any other suitable material known in the art.

The peg support member 100 may comprise any number of posts 115 and/or openings 117 according to the present invention. For example, body 110 may have two, three, or more posts 115 radially-arrayed about one opening 117, the posts 115 each being adapted to receive a peg board opening 104 proximate the peg board opening 104 receiving the peg 105. In this way, the holding or coupling characteristics of the peg support member 100 may be adapted as desired. Similarly, body 110 may have two, three, or more openings 117 disposed proximate one or more posts 115, each opening 117 being adapted to receive a peg 105 for independently-removable coupling of the pegs 105 to the peg board 103, which simultaneously provides for improved holding or coupling characteristics, as desired.

Furthermore, multiple peg support members 100 may be used, such as in a modular, stackable configuration. For example, a first peg support member 100 may couple one or more posts 115 to corresponding one or more peg board openings 104, first peg support member 100 further including two openings 117 disposed adjacent one another. A second peg support member 100 including one post 115 and one opening 117 may then be disposed on top of the first peg support member 100, wherein the one post of the second peg support member 100 is inserted into either of the openings 117 of the first peg support member 100. The remaining openings of each of the first and second peg support members 100 may then be aligned and adapted to receive a common peg 105. In this example, first and second peg support members 100 may comprise bodies 110 having the same height-which would double the surface area interface provided by the peg support members 100, and may thereby triple the surface area interface provided to the peg 105 by the peg board opening 104 alone. Other modular configurations are considered within the scope of this disclosure and are non-limiting thereto.

Referring to FIGS. 7A-7E, a preferred embodiment of peg support member 100 is described in the context of a method of assembly in the environment of positioning a patient 107 in a lateral decubitus position by positioning a peg 105 for support of the patient 107 proximate the pubis synthesis. Referring to FIG. 7A, in a step 400, a peg support member 100 is provided. The patient 107 may be located on one or more pads 106 disposed on one or more peg boards 103, in turn disposed on an OR table 101. The peg board 103 may have one or more peg board openings 104, each configured to receive a peg 105 as desired by the surgeon or nurse, and according to the size and physical profile of the patient 107. The peg board 103 may be fixedly coupled to the OR table 101 via one or more side rails 102, thereby, when in a completely-assembled configuration the patient is securely held in position with respect to the ground, or with respect to x-, y-, and z-axes of a coordinate system of a surgical robot or similar device.

Referring to FIG. 7B, in a step 401, the surgeon (not shown) may reach under the side of the patient 107 under the pad 106 as represented by direction D1. This provides the surgeon with access a desired peg board opening 104. The post 115 of peg support member 100 may be inserted into peg board opening 104 as represented by direction D2, wherein the post 115 is entirely inserted therein so that bottom 112 mates to the peg board 103 surface. In this embodiment, peg support member 100 may be pivotably-rotatable about post 115 and relative to peg board 103 to advance or retract the position of the opening 117 relative to the patient 107.

Referring to FIG. 7C, in a step 402, a peg 105 may be at least partially inserted into opening 117 of body 110, but not so far as to be inserted into a peg board opening 104, so that the peg support member 100 remains pivotably-rotatable about post 115 and relative to peg board 103 to advance or retract the position of the post 105 relative to the patient 107. This positioning is represented in direction D3. The surgeon and support staff may continue to hold the pad 106 and/or patient 107 back away from the area of the peg support member 100.

Referring to FIG. 7D, in a step 403, a number of peg board openings 104 may align with opening 117 of body 110 and peg 105, and the surgeon may ultimately advance the peg 105 to a desired peg board opening 104 accordingly, such as in direction D4. In some embodiments, the peg board 103 may contain peg board openings 104 that are arrayed 2 inches, center-on-center, from one or more adjacent peg board openings 104. When the post 115 and opening 117 of peg support member 100 are similarly distanced 2 inches, center-on-center, peg 105 may be advantageously positioned in the one or more adjacent peg board openings 104. By holding the peg support member 100 such as along ergonomic grip 114, and/or by holding along peg 105, the peg 105 may be selectively advanced while maintaining a vertical/upright position for subsequent insertion into the desired peg board opening 104.

Referring to FIG. 7E, in a step 404, peg 105 may be inserted into a peg board opening 104. As shown, peg support member 100 provides improved holding and/or coupling characteristics of the peg 105 within peg board opening 104. This improved holding, in turn, more securely positions and maintains the positioning of the patient 107. Furthermore, by increasing the surface area interface between the peg 105 and the support structures—i.e., peg board opening 104 and opening 117—the angular deflection α is reduced or substantially eliminated.

The previous description of the disclosed embodiments is provided to enable any person skilled in the art to make or use the invention. Various modifications to these embodiments will be readily apparent to those skilled in the art, and the principles defined herein can be applied to other embodiments without departing from the spirit or scope of the invention. It is therefore desired that the present embodiments be considered in all respects as illustrative and not restrictive, reference being made to the appended claims as well as the foregoing descriptions to indicate the scope of the invention.

What is claimed is:

1. A peg support member for coupling of a peg to a first peg board opening for positioning a patient during surgery, the peg support member comprising:
a body having a top offset from a bottom and a side having a tapered profile disposed between said top and said bottom,
a post disposed outwardly from said body, the post adapted to couple to a second peg board opening of a peg board; and
an opening adapted to receive said peg, wherein in an assembled configuration, said peg passes through said opening of said body to couple to said first peg board opening, said opening characterized by a body inner surface area, said peg board opening characterized by a peg board inner surface area.

2. The peg support member of claim 1, wherein said body inner surface area is sized to at least double the peg board inner surface area.

3. A method of supporting a peg comprising:
providing a peg support member according to claim 1;
lifting a pad supporting a patient thereunder;
inserting said peg support member into a first peg board opening;
inserting, at least partially, said peg into said opening so that said peg support member is pivotably-rotatable about said post and relative to said peg board, to advance or retract the position of said peg relative to said patient;
rotating said peg support member to advance said opening to align with said second peg board opening; and
inserting said peg into said second peg board opening.

4. The method of supporting a peg of claim 3, wherein said body inner surface area is sized to at least double the peg board inner surface area.

5. A peg support system for positioning a patient during surgery, the peg support system comprising:
a peg support member according to claim 1;
a peg board coupled to a support table;
a peg for operably coupling to said peg board and said peg support member;
one or more peg pads configured to receive said peg in a centrally disposed opening; and
a peg board pad disposed between said peg board and said patient.
